(19) United States
(12) Patent Application Publication
(10) Pub. No.: US 2020/0098496 A1
(43) Pub. Date: Mar. 26, 2020

(54) RARE EARTH MAGNET AND PRODUCTION METHOD THEREOF

(71) Applicants: TOYOTA JIDOSHA KABUSHIKI KAISHA, Toyota-shi (JP); TOHOKU UNIVERSITY, Sendai-shi (JP)

(72) Inventors: Akihito KINOSHITA, Mishima-shi (JP); Noritsugu SAKUMA, Mishima-shi (JP); Tetsuya SHOJI, Susono-shi (JP); Daisuke ICHIGOZAKI, Toyota-shi (JP); Tatsuhiko HIRANO, Toyota-shi (JP); Kazuaki HAGA, Toyota-shi (JP); Yukio TAKADA, Nagakute-shi (JP); Satoshi SUGIMOTO, Sendai-shi (JP); Masashi MATSUURA, Sendai-shi (JP)

(73) Assignees: TOYOTA JIDOSHA KABUSHIKI KAISHA, Toyota-shi (JP); TOHOKU UNIVERSITY, Sendai-shi (JP)

(21) Appl. No.: 16/576,215

(22) Filed: Sep. 19, 2019

(30) Foreign Application Priority Data
Sep. 21, 2018 (JP) 2018-178085

(51) Int. Cl. H01F 1/059; H01F 41/02; B22F 3/24; C22C 18/02; C22C 38/00

(52) U.S. Cl. CPC H01F 1/0596; H01F 41/0266; B22F 3/24; C22C 18/02; C22C 2202/02; B22F 2003/248; B22F 2301/355; B22F 2301/30; C22C 38/005

(57) ABSTRACT

To provide a rare earth magnet in which particles of SmFeN powder are bound using a Zn alloy powder, wherein generation of a knick at a magnetic field of around 0 is prevented, and a production method thereof.

A rare earth magnet including a main phase containing Sm, Fe, and N, at least a part of the main phase having a Th₂Zn₁₇-type or Th₂Ni₁₇-type crystal structure, a sub-phase containing at least either Si or Sm, and Zn and Fe and being present around the main phase, and an intermediate phase containing Sm, Fe and N as well as Zn and being present between the main phase and the sub-phase, wherein the average Fe content in the sub-phase is 33 at % or less relative to the whole sub-phase, and the average total content of Si and Sm in the sub-phase is from 1.4 to 4.5 at % relative to the whole subs-phase.

### TECHNICAL FIELD

The present disclosure relates to a rare earth magnet, particularly, a rare earth magnet containing Sm, Fe and N, at least a part thereof including a phase having a Th₂Zn₁₇-type or Th₂Ni₁₇-type crystal structure, and a production method thereof.

### BACKGROUND ART

As a high-performance rare earth magnet, an Sm—Co-based rare earth magnet and a Nd—Fe—B-based rare earth magnet are put into practical use, but in recent years, a rare earth magnet other than these is being studied.

For example, a rare earth magnet containing Sm, Fe and N (hereinafter, sometimes referred to as “Sm—Fe—N-based rare earth magnet”) is being studied. In the Sm—Fe—N-based rare earth magnet, N is considered to form an interstitial solid solution in a Sm—Fe crystal.

The Sm—Fe—N-based rare earth magnet is produced using, for example, a magnetic powder containing Sm, Fe and N (hereinafter, sometimes referred to as “SmFeN powder”). In the SmFeN powder, N is likely to dissociate and decompose due to heat. Accordingly, the Sm—Fe—N-based rare earth magnet is often produced by molding a SmFeN powder with use of a resin and/or rubber, etc.

As the production method of a Sm—Fe—N-based rare earth magnet other than the above, for example, Patent Document 1 discloses a production method of mixing a SmFeN powder and a Zn powder, molding the mixture, and heat-treating the molded body.

### RELATED ART

### Patent Document

[Patent Document 1] Japanese Unexamined Patent Publication No. 2015-201628

### SUMMARY OF THE INVENTION

### Technical Problem

In the production method of a rare earth magnet disclosed in Patent Document 1, a SmFeN powder and a Zn powder are heat-treated together at a temperature lower than the temperature at which N of the SmFeN powder dissociates and decomposes, and Zn thereby functions as a bond for binding particles of the SmFeN powder. However, as found by the present inventors, the rare earth magnet disclosed in Patent Document 1 has a problem that a knick is generated at a magnetic field of around 0 in the M-H curve and the residual magnetic flux density Br decreases. Incidentally, the knick indicates that in a region other than the coercive force region of the M-H curve (magnetization-magnetic field curve), the magnetization is rapidly reduced with a slight decrease in the magnetic field.

The present disclosure has been made to solve the above-described problem. More specifically, an object of the present invention is to provide a rare earth magnet in which particles of SmFeN powder are bound using a Zn alloy powder, wherein generation of a knick at a magnetic field of around 0 is prevented, and a production method thereof.

### Solution to Problem

The present inventors have made many intensive studies so as to attain the object above and accomplished the rare earth magnet of the present disclosure and the production method thereof. The rare earth magnet of the present disclosure and the production method thereof include the following embodiments.

<1> A rare earth magnet including

a main phase containing Sm, Fe, and N, at least a part of the main phase having a Th₂Zn₁₇-type or Th₂Ni₁₇-type crystal structure,

a sub-phase containing at least either Si or Sm, and Zn and Fe and being present around the main phase, and

an intermediate phase containing Sm, Fe and N as well as Zn and being present between the main phase and the sub-phase,

wherein the average Fe content in the sub-phase is 33 at % or less relative to the whole sub-phase, and the average total content of Si and Sm in the sub-phase is from 1.4 to 4.5 at % relative to the whole subs-phase.

<2> The rare earth magnet according to item <1>, wherein the average Fe content in the sub-phase is from 1 to 33 at % relative to the whole sub-phase.

<3> The rare earth magnet according to item <1> or <2>, wherein the sub-phase further contains Cu.

<4> The rare earth magnet according to item <1> or <2>, wherein the sub-phase contains one or more Zn—Fe alloy phases selected from the group consisting of a Γ phase, a Γ₁ phase, a δ₁ₖ phase, a δ₁ₚ phase, and a ζ phase and at least a part of Zn or Fe of the Zn—Fe alloy phase is substituted by at least either Si or Sm.

<5> The rare earth magnet according to item <4>, wherein at least a part of Zn or Fe of the Zn—Fe alloy phase is further substituted by Cu.

<6> The rare earth magnet according to any one of items <1> to <5>, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

<7> The rare earth magnet according to any one of items <1> to <5>, wherein the main phase contains a phase represented by Sm₂Fe₁₇Nₕ (wherein h is from 1.5 to 4.5).

<8> The rare earth magnet according to any one of items <1> to <5>, wherein the main phase contains a phase represented by Sm₂Fe₁₇N₃.

<9> A method for producing a rare earth magnet, including:

mixing a magnetic powder and a Zn alloy powder to obtain a mixed powder, the magnetic powder including a main phase containing Sm, Fe, and N, at least a part of the main phase having a Th₂Zn₁₇-type or Th₂Ni₁₇-type crystal structure, the Zn alloy powder containing, as an alloy element, at least either Si or Sm,

heat-treating the mixed powder at a temperature equal to or higher than the temperature allowing Zn to diffuse into the oxide phase on the surface of the main phase and less than the decomposition temperature of the main phase.

<10> The method according to item <9>, wherein the Si content in the Zn alloy powder is from 0.7 to 1.1 mass % relative to the Zn alloy powder.

<11> The method according to item <9> or <10>, wherein the Sm content in the Zn alloy powder is from 3.2 to 4.4 mass % relative to the Zn alloy powder.

<12> The method according to any one of items <9> to <11>, wherein the Zn alloy powder further contains Cu.

<13> The method according to any one of items <9> to <11>, wherein the Cu content in the Zn alloy powder is from 0.6 to 4.9 mass % relative to the Zn alloy powder.

<14> The method according to any one of items <9> to <13>, wherein the mixed powder is compression-molded to obtain a green compact and the green compact is heat-treated.

<15> The method according to item <14>, wherein the compression molding is performed in a magnetic field.

<16> The method according to any one of items <9> to <15>, wherein the mixed powder or green compact is heat-treated while pressure is applied.

<17> The method according to any one of items <9> to <16>, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

<18> The method according to any one of items <9> to <16>, wherein the main phase contains a phase represented by Sm₂Fe₁₇Nₕ (wherein h is from 1.5 to 4.5).

<19> The method according to any one of items <9> to <16>, wherein the main phase contains a phase represented by Sm₂Fe₁₇N₃.

<20> The method according to any one of items <9> to <19>, wherein the heat treatment is performed at 350 to 500° C.

<21> The method according to any one of items <9> to <19>, wherein the heat treatment is performed at 420 to 500° C.

### Advantageous Effects of the Invention

According to the present disclosure, the Fe content in the sub-phase present around the main phase is a predetermined amount or less, so that a rare earth magnet capable of preventing generation of a knick at a magnetic field of around 0 can be provided. In addition, according to the present disclosure, a method for producing a rare earth magnet, in which Si or Sm in the Zn alloy powder prevents Fe in the main phase surface from diffusing into the sub-phase and generation of a knick at a magnetic field of around 0 is thereby prevented, can be provided.

### BRIEF DESCRIPTION OF THE DRAWINGS

FIG. 1 is a schematic diagram illustrating a portion of the microstructure with respect to the rare earth magnet of the present disclosure.

FIG. 2 is a schematic diagram illustrating the state of the mixed powder before heat treatment in the production method of a rare earth magnet of the present disclosure.

FIG. 3 is an Fe—Zn binary equilibrium phase diagram.

FIG. 4 is an M-H curve with respect to Examples 1 and 2 and Comparative Example 1.

FIG. 5 is a diagram enlarging the region where the magnetic field is 0 MA/m in FIG. 4.

FIG. 6 is a schematic diagram illustrating the state of the SmFeN powder particle surface being coated with Zn in the production method of a conventional rare earth magnet.

FIG. 7 is a schematic diagram enlarging the portion surrounded by a square in FIG. 6.

FIG. 8 is a schematic diagram illustrating a portion of the microstructure with respect to a conventional rare earth magnet.

### MODE FOR CARRYING OUT THE INVENTION

The embodiments of the rare earth magnet of the present disclosure and the production method thereof are described in detail below. Incidentally, the embodiments set forth below should not be construed to limit the rare earth magnet of the present disclosure and the production method thereof.

The conventional rare earth magnet obtained by heat-treating a mixed powder of SmFeN powder and Zn powder has the following problem due to its production method. The problem is described using the drawings. When a SmFeN powder and a Zn powder are mixed, since the Zn powder particle is softer than the SmFeN powder particle, the outer periphery of the SmFeN powder particle is coated with Zn coat.

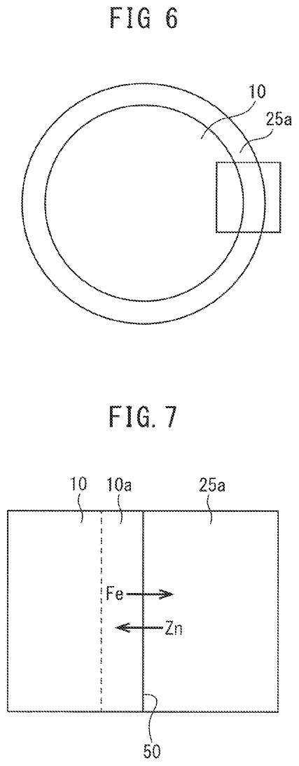

FIG. 6 is a schematic diagram illustrating the state of the SmFeN powder particle surface being coated with Zn in the production method of a conventional rare earth magnet. In FIG. 6, the main phase 10 is derived from the SmFeN powder particle, and the Zn phase 25a is derived from the Zn powder particle.

FIG. 7 is a schematic diagram enlarging the portion surrounded by a square in FIG. 6. The main phase 10 and the Zn phase 25a are contacted at an interface 50. The main phase 10 is susceptible to oxidation, and therefore the main phase 10 surface has an oxide phase 10a. In FIG. 7, the dashed line denotes a region where the oxide phase 10a is present. When a mixed powder of SmFeN powder and Zn powder is heat-treated, Zn diffuses from the Zn phase 25a to the oxide phase 10a, and the Zn combines with oxygen of the oxide phase 10a to form an intermediate phase. The intermediate phase is described later. In the oxide phase 10a, Fe not constituting the main phase 10 is present, and therefore, when a mixed powder of SmFeN powder and Zn powder is heat-treated, Fe diffuses from the main phase 10 to the Zn phase 25a. In this way, the conventional rare earth magnet is obtained.

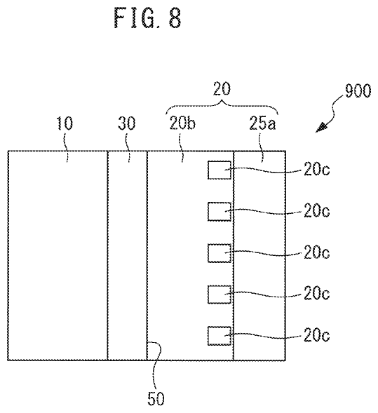

FIG. 8 is a schematic diagram illustrating a portion of the microstructure with respect to the conventional rare earth magnet 900. As a result of diffusion of Zn from the Zn phase 25a to the oxide phase 10a (see, FIG. 7), an intermediate phase 30 is formed at the position of oxide phase 10a (see, FIG. 8). In addition, as a result of diffusion of Fe from the oxide phase 10a to the Zn phase 25a (see, FIG. 7), a Zn—Fe alloy phase 20b is formed on the interface 50 side of the Zn phase 25a (see, FIG. 8) and at this time, if the amount of Fe diffused from the oxide phase 10a to the Zn—Fe alloy phase 20b is large, an a-Fe phase 20c is produced inside of the Zn—Fe alloy phase 20b.

Although the main phase 10 is a hard magnetic phase and the a-Fe phase 20c is a soft magnetic phase, as illustrated in FIG. 8, the main phase 10 and the a-Fe phase 20c are not present adjacent to each other, and exchange coupling does not act therebetween. Accordingly, the a-Fe phase 20c gives rise to a knick.

The oxide phase 10a becomes an intermediate phase 30 due to diffusion of Zn from the Zn phase 25a and contributes to enhancement of the coercive force by magnetically dividing adjacent main phases 10 from each other. Since Fe has high affinity for Zn, Fe present in the oxide phase 10a is likely to diffuse into the Zn phase 25a, and diffusion of a large amount of Fe generates production of an α-Fe phase 20c inside of the Zn—Fe alloy phase 20b. Even when diffusion of Fe present in the oxide phase 10a is suppressed and Fe remains inside of the intermediate phase 30 produced due to diffusion of Zn, since the main phase 10 (hard magnetic) and Fe (soft magnetic) inside of the intermediate phase 30 are contiguous, exchange coupling acts therebetween, contributing to enhancement of magnetization, and a knick is not generated.

The present inventors have found that such diffusion of a large amount of Fe may be suppressed when a mixed powder of SmFeN powder and Zn alloy powder. It has also been found that the Zn alloy is sufficient if it is a Zn-based alloy containing at least either Si or Sm. In addition, the present inventors have found that when diffusion of a large amount of Fe is suppressed, an α-Fe phase 20c can be prevented from being produced inside of the Zn—Fe alloy phase 20b, as a result, generation of a knick can be inhibited.

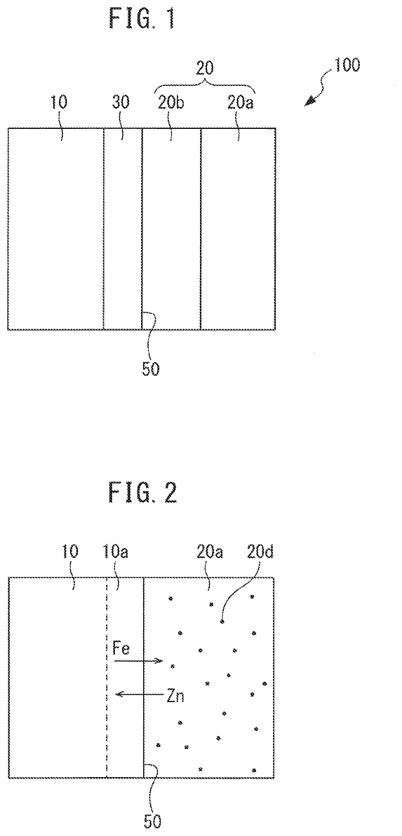

These findings are described by further referring to additional drawings. FIG. 1 is a schematic diagram illustrating a portion of the microstructure with respect to the rare earth magnet of the present disclosure. In the production of the rare earth magnet 100 of the present disclosure, a mixed powder of SmFeN powder and Zn alloy powder is used. FIG. 2 is a schematic diagram illustrating the state of the mixed powder before heat treatment in the production method of a rare earth magnet of the present disclosure.

As illustrated in FIG. 2, in the mixed powder, the main phase 10 derived from SeFeN and the Zn alloy phase 20a derived from the Zn alloy powder are contacted at an interface 50. An oxide phase 10a is present on the main phase 10 surface. The Zn alloy phase 20a contains an alloy element 20d inside thereof. The alloy element 20d contains at least either Si or Sm. When the mixed powder of SmFeN powder and Zn alloy powder is heat-treated, Zn diffuses from the Zn alloy phase 20a to the oxide phase 10a (see, FIG. 2), and the Zn combines with oxygen of the oxide phase 10a to form an intermediate phase 30 (see, FIG. 1). In addition, Fe diffuses from the main phase 10 to the Zn alloy phase 20a (see, FIG. 2), and a Zn—Fe alloy phase 20b is formed on the interface 50 side of the Zn phase 25a (see, FIG. 1). At this time, although not bound by theory, the alloy element 20d present on the surface and in the inside of the Zn alloy phase 20a reduces the amount of Fe diffused from the oxide phase 10a to the Zn alloy phase 20a. As a result, the Fe content does not become excessive inside of the Zn—Fe alloy phase 20b and therefore, the production of an α-Fe phase 20c (see, FIG. 8) is suppressed.

Although not bound by theory, the alloy element 20d is considered to act as an obstacle to the diffusion of Fe or reduce the diffusion rate of Fe.

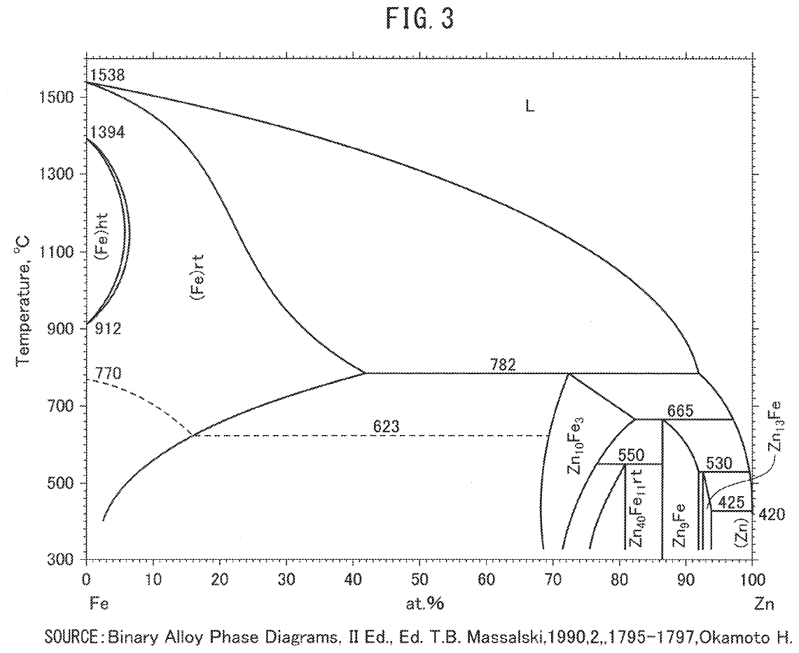

The reason why when the amount of Fe diffused from the oxide phase 10a to the Zn alloy phase 20a is reduced, production of an α-Fe phase inside of the Zn—Fe alloy phase 20b can be suppressed is described using an equilibrium phase diagram. FIG. 3 is a Fe—Zn binary equilibrium phase diagram. The source therefor is Binary Alloy Phase Diagrams, II Ed., Ed. T. B. Massalski, 1990, 2, 1795-1797, Okamoto H. The content of the alloy element 20d in the Zn alloy phase 20a is comparatively small. Accordingly, although not bound by theory, the Zn alloy phase 20a becomes a Zn—Fe alloy phase 20b due to diffusion of Fe and even when the alloy element 20d remains inside of the Zn—Fe alloy phase 20b, the alloy element 20d is considered to less affect the crystal structure of the Zn—Fe alloy phase 20b.

In FIG. 3, the region denoted by “(Fe)ᵣₜ” indicates an α-Fe phase; the region denoted by “Zn₁₀Fe₃” indicates a Γ phase; the region denoted by “Zn₄₀Fe₁₁ᵣₜ” indicates a Γ₁ phase; the region denoted by “Zn₉Fe” indicates a δ₁ₖ phase or a δ₁ₚ phase; and the region denoted by “Zn₁₃Fe” indicates a ζ phase. Incidentally, as seen from FIG. 3, the α-Fe phase forms a solid solution with a small amount of Zn at 300° C. or less. Accordingly, in the present description, unless otherwise indicated, the α-Fe phase encompasses an α-(Fe, Zn) phase having formed therein a solid solution of a small amount of Zn.

As understood from FIG. 3, when the Fe content in an Fe—Zn binary system is 33 at % or less, the Γ phase, Γ₁ phase, δ₁ₖ phase, δ₁ₚ phase and phase are stable. It can therefore be understood that when the Fe content is 33 at % or less, an α-Fe phase is less likely to be produced. Describing by referring to FIG. 2 (a diagram illustrating the state before heat treatment) and FIG. 1 (a diagram illustrating the state after heat treatment), this is as follows. Even when Fe diffuses from the oxide phase 10a to the Zn alloy phase 20a (see, FIG. 2) as a result of heat treatment and a Zn—Fe alloy phase 20b is formed (see, FIG. 1), since an alloy element 20d of FIG. 2 is present, the amount of Fe diffused is not so large. This suggests that in FIG. 2, the Fe content in total in the Zn—Fe alloy phase 20b and the Zn alloy phase 20a becomes 33 at % or less and an α-Fe phase can hardly be produced inside of the Zn—Fe alloy phase 20b. The alloy element 20d having been present in the Zn alloy phase 20a before heat treatment remains in the Zn alloy phase 20a and the Zn—Fe alloy phase 20b after heat treatment.

On the other hand, in the production method of a conventional rare earth magnet, since the alloy element 20d of FIG. 2 is not present (see, FIG. 7), a large amount of Fe diffuses from the oxide phase 10a to the Zn alloy phase 20a due to heat treatment. As a result, the Fe content in total in the Zn—Fe alloy phase 20b and the Zn alloy phase 20a exceeds 33 at %, and therefore, as illustrated in FIG. 8, an α-Fe phase 20c is considered to be readily produced.

In FIG. 1 (the rare earth magnet 100 of the present disclosure) and FIG. 8 (the conventional rare earth magnet 900), the Zn alloy phase 20a and Zn—Fe alloy phase 20b derived from the Zn alloy powder at the time of production of those rare earth magnets are referred to as the sub-phase 20 for convenience sake. Then, the rare earth magnet 100 of the present disclosure of FIG. 1 has a main phase 10, a sub-phase 20, and an intermediate phase 30; the intermediate phase 30 is present between the main phase 10 and the sub-phase 20; and the average Fe content in the sub-phase 20 is 33 at % or less, relative to the whole sub-phase 20. On the other hand, the conventional rare earth magnet of FIG. 8 has a main phase 10, a sub-phase 20, and an intermediate phase 30; the intermediate phase 30 is present between the main phase 10 and the sub-phase 20; and the average Fe content in the sub-phase 20 exceeds 33 at % relative to the whole sub-phase 20. Accordingly, in the conventional rare earth magnet 900, an α-Fe phase 20c is present inside of the Zn—Fe alloy phase 20b.

The constituent features of the rare earth magnet of the present disclosure and the production thereof, which have been accomplished based on the findings discussed hereinbefore, are described below.

### <<Rare Earth Magnet>>

As illustrated in FIG. 1, the rare earth magnet 100 of the present disclosure has a main phase 10, a sub-phase 20, and an intermediate phase 30. FIG. 1 illustrates a portion of the microstructure of the rare earth magnet 100 of the present disclosure. In the rare earth magnet 100 of the present disclosure, a plurality of main phases 10 and a plurality of intermediate phases 30 therearound are present, and these are connected by sub-phases 20. Each of the main phase 10, the sub-phase 20 and the intermediate phase 30 is described below.

### <Main Phase>

The rare earth magnet 100 of the present disclosure exhibits magnetism owing to the main phase 10. The main phase 10 contains Sm, Fe and N. The main phase 10 may contain R¹ as long as it does not inhibit the effects of the rare earth magnet 100 of the present disclosure and the production method thereof. R¹ is one or more elements selected from the group consisting of Y, Zr, and rare earth elements other than Sm. In addition, a part of Fe may be substituted by Co. Such a main phase 10, when expressed by the molar ratio of Sm, R¹, Fe, Co and N, is (Sm₍₁₋ᵢ₎R¹ᵢ)₂(Fe₍₁₋ⱼ₎Coⱼ)₁₇Nₕ. Here, h is preferably 1.5 or more, more preferably 2.0 or more, still more preferably 2.5 or more, and on the other hand, h is preferably 4.5 or less, more preferably 4.0 or less, still more preferably 3.5 or less. In addition, i may be 0 or more, 0.10 or more, or 0.20 or more, and may be 0.50 or less, 0.40 or less, or 0.30 or less, and j may be 0 or more, 0.10 or more, or 0.20 or more, and may be 0.52 or less, 0.40 or less, or 0.30 or less.

With respect to (Sm₍₁₋ᵢ₎R¹ᵢ)₂(Fe₍₁₋ⱼ₎Coⱼ)₁₇Nₕ, typically, R¹ is substituted at the position of Sm of Sm₂(Fe₍₁₋ⱼ₎Coⱼ)₁₇Nₕ, but the configuration is not limited thereto. For example, R¹ may be interstitially disposed in Sm₂(Fe₍₁₋ⱼ₎Coⱼ)₁₇Nₕ.

In addition, with respect to (Sm₍₁₋ᵢ₎R¹ᵢ)₂(Fe₍₁₋ⱼ₎Coⱼ)₁₇Nₕ, typically, Co is substituted at the position of Fe of (Sm₍₁₋ᵢ₎R¹ᵢ)₂Fe₁₇Nₕ, but the configuration is not limited thereto. For example, Co may be interstitially disposed in (Sm₍₁₋ᵢ₎R¹ᵢ)₂Fe₁₇Nₕ.

Furthermore, with respect to (Sm₍₁₋ᵢ₎R¹ᵢ)₂(Fe₍₁₋ⱼ₎Coⱼ)₁₇Nₕ, h may be from 1.5 to 4.5, but typically, the configuration is (Sm₍₁₋ᵢ₎R¹ᵢ)₂(Fe₍₁₋ⱼ₎Coⱼ)₁₇N₃. The content of (Sm₍₁₋ᵢ₎R¹ᵢ)₂(Fe₍₁₋ⱼ₎Coⱼ)₁₇N₃ relative to the whole (Sm₍₁₋ᵢ₎R¹ᵢ)₂(Fe₍₁₋ⱼ₎Coⱼ)₁₇Nₕ is preferably 70 mass % or more, more preferably 80 mass % or more, still more preferably 90 mass %. On the other hand, (Sm₍₁₋ᵢ₎R¹ᵢ)₂(Fe₍₁₋ⱼ₎Coⱼ)₁₇Nₕ need not be entirely (Sm₍₁₋ᵢ₎R¹ᵢ)₂(Fe₍₁₋ⱼ₎Coⱼ)₁₇N₃. The content of (Sm₍₁₋ᵢ₎R¹ᵢ)₂(Fe₍₁₋ⱼ₎Coⱼ)₁₇N₃ relative to the whole (Sm₍₁₋ᵢ₎R¹ᵢ)₂(Fe₍₁₋ⱼ₎Coⱼ)₁₇Nₕ may be 98 mass % or less, 95 mass % or less, or 92 mass % or less.

The content of the main phase 10 relative to the whole rare earth magnet 100 of the present disclosure may be appropriately determined by taking into account of coating or binding of particles of the magnetic powder containing the main phase 10 with a Zn alloy powder. The content of the main phase 10 relative to the whole rare earth magnet 100 of the present disclosure may be, for example, 20 mass % or more, 30 mass % or more, 40 mass % or more, 50 mass % or more, 60 mass % or more, 70 mass % or more, or 80 mass % or more. The content of the main phase 10 relative to the whole rare earth magnet 100 of the present disclosure is not 100 mass %, because the rare earth magnet 100 of the present disclosure contains a sub-phase 20 and an intermediate phase 30. On the other hand, in order to ensure appropriate amounts of sub-phase 20 and intermediate phase 30, the content of the main phase 10 relative to the whole rare earth magnet 100 of the present disclosure may be 99 mass % or less, 95 mass % or less, or 90 mass % or less.

The content of Sm₂(Fe₍₁₋ᵢ₎Coᵢ)₁₇Nₕ relative to the whole main phase 10 is preferably 90 mass % or more, more preferably 95 mass % or more, still more preferably 98 mass % or more. The content of Sm₂(Fe₍₁₋ᵢ₎Coᵢ)₁₇Nₕ relative to the whole main phase 10 is not 100 mass %, because the main phase 10 may contain a phase other than Sm₂(Fe₍₁₋ᵢ₎Coᵢ)₁₇Nₕ.

The main phase 10 of the rare earth magnet 100 of the present disclosure contains a phase that can be contained as a magnetic phase of a Sm—Fe—N-based rare earth magnet. Such a phase includes, for example, a phase having a Th₂Zn₁₇-type crystal structure, a phase having a Th₂Ni₁₇-type crystal structure, and a phase having a TbCu₇-type crystal structure.

The particle diameter of the main phase 10 is not particularly limited. The particle diameter of the main phase 10 may be, for example, 1 μm or more, 5 μm or more, or 10 μm or more, and may be 50 μm or less, 30 μm or less, or 20 μm or less. In the present description, unless otherwise indicated, the particle diameter means an equivalent-circle diameter of projected area, and in the case where the particle diameter is indicated with a range, 80% or more of all main phases 10 are distributed in that range.

### <Sub-Phase>

A sub-phase 20 is present around the main phase 10. As described later, an intermediate layer 30 is present between the main phase 10 and the sub-phase 20, and therefore the sub-phase 20 is present in the outer periphery of the intermediate phase 30.

As illustrated in FIG. 1, the sub-phase 20 has a Zn alloy phase 20a and a Zn—Fe alloy phase 20b. More specifically, on the intermediate phase 30 side of the sub-phase 20, the Zn alloy phase 20a is further alloyed with Fe. Accordingly, the sub-phase 20 contains a constituent element of the Zn alloy phase 20a and Fe. That is, the sub-phase 20 contains at least either Si or Sm, and Zn and Fe.

As described above, when the average Fe content in the sub-phase 20 is 33 at % or less relative to the whole sub-phase 20, production of an α-Fe phase 20c inside of the Zn—Fe alloy phase 20b can be suppressed (see, FIG. 8). As a result, generation of a knick at a magnetic field of around 0 can be prevented. From the viewpoint of suppressing the production of α-Fe phase 20c, the average Fe content in the sub-phase 20 is preferably 30 at % or less, more preferably 20 at % or less, still more preferably 15 at % or less.

On the other hand, from the viewpoint of suppressing the production of α-Fe phase 20c inside of the Zn—Fe alloy phase 20b, the average Fe content in the sub-phase 20 is preferably smaller within the range of 33 at % or less, but there is substantially no problem even when it is not 0. Accordingly, the average Fe content in the sub-phase 20 may be 1 at % or more, 3 at % or more, or 5 at % or more.

The average total content of Si and Sm in the sub-phase 20 is from 1.4 to 4.5 at % relative to the whole subs-phase 20. Since Si and Sm in the Zn alloy powder remain in the sub-phase 20, the above-described average total content of Si and Sm corresponds to the composition of the later-described Zn alloy powder. The same applies to alloy elements other than Si and Sm in the Zn alloy powder. Out of the sub-phase 20, in the Zn—Fe alloy phase 20b, at least a part of Zn or Fe of the Zn—Fe alloy phase 20b may be substituted by an alloy element of the Zn alloy powder. More specifically, at least a part of Zn or Fe of the Zn—Fe alloy phase 20b may be substituted by at least either Si or Sm. In the case where the later-described Zn alloy powder contains Cu, the sub-phase 20 may further contain Cu. At this time, the average Cu content in the sub-phase 20 may be from 0.6 to 5.0 at %. At least a part of Zn or Fe of the Zn—Fe alloy phase 20b may further be substituted by Cu. As long as the content of the alloy element in the Zn alloy powder is within the range described later, the phase that the sub-phase 20 described below can contain may be considered as a Zn—Fe binary system without any substantial problem.

As understood from the phase diagram of FIG. 3, since the Fe content in the sub-phase 20 is 33 at % or less, the phases that the sub-phase 20 can contain are the Zn alloy phase 20a and, as the Zn—Fe alloy phase 20b, a Γ phase (Zn₁₀Fe₃), a Γ₁ phase (Zn₄₀Fe₁₁ᵣₜ), δ₁ₖ and δ₁ₚ phases (Zn₉Fe), and a ζ phase (Zn₁₃Fe). The saturation magnetization of each of these phases is shown in Table 1. Here, in Table 1, the results of measuring the saturation magnetization of a ribbon prepared by rapidly cooling a molten alloy having the composition on the phase diagram of each phase are shown.

TABLE 1

| Phase | Saturation Magnetization (emu/g) |
|---|---|
| ζ phase | <0.1 |
| δ1p phase | <0.1 |
| δ1k phase | <0.1 |
| Γ1 phase | <0.1 |
| Γ phase | 6 |
| α phase | 215 |
| Sm2Fe17N3 phase | 154 |

The saturation magnetizations of Γ₁ phase, δ₁ₖ phase, δ₁ₚ phase and ζ phase are extremely low, and the saturation magnetization of phase is very small compared with α-Fe phase. Accordingly, in order to prevent generation of a knick at a magnetic field of around 0, the sub-phase 20 may contain one or more Zn—Fe alloy phases selected from the group consisting of a Γ phase, a Γ₁ phase, a δ₁ₖ phase, a δ₁ₚ phase, and a ζ phase. In particular, the sub-phase 20 may contain one or more Zn—Fe alloy phases selected from the group consisting of a Γ₁ phase, a δ₁ₖ phase, a δ₁ₚ phase, and a ζ phase. Incidentally, each of the Γ phase, Γ₁ phase, δ₁ₖ phase, δ₁ₚ phase and ζ phase may include an intermetallic compound other than the Zn—Fe alloy phase.

As understood from FIG. 3, the Fe content decreases in order of Γ phase, Γ₁ phase, δ₁ₖ phase, δ₁ₚ phase and ζ phase (the Fe content is largest in the Γ phase). Accordingly, as the Fe content in the sub-phase 20 decreases, the Γ phase is less likely to be present, and it is easy to prevent generation of a knick at a magnetic field of around 0.

The thickness of the sub-phase 20 is not particularly limited as long as the average Fe content is in the above-described range and the production of α-Fe phase can be suppressed. The thickness of the sub-phase 20 may be typically 1 nm or more, 10 nm or more, 50 nm or more, 100 nm or more, 250 nm, or 500 nm or more, and may be 100 μm or less, 50 μm or less, or 1 μm or less.

### <Intermediate Phase>

As illustrated in FIG. 1, an intermediate phase 30 is present between the main phase 10 and the sub-phase 20. The intermediate phase 30 is formed as a result of diffusion of Zn into the oxide phase 10a of the main phase 10 illustrated in FIG. 2. Accordingly, the intermediate phase contains Sm, Fe and N as well as Zn. Diffusion of Zn magnetically divides the main phases 10 and contributes to enhancement of the coercive force.

When the Zn content in the intermediate phase 30 is 5 at % or more relative to the whole intermediate phase 30, the enhancement of coercive force due to the intermediate phase 30 can be clearly recognized. From the viewpoint of enhancing the coercive force, the Zn content in the intermediate phase 30 is preferably 10 at % or more, more preferably 15 at % or more. On the other hand, when the Zn content in the intermediate phase 30 is 50 at % or less relative to the whole intermediate phase 30, reduction in the magnetization can be suppressed. From the viewpoint of suppressing the reduction in magnetization, the Zn content in the intermediate phase 30 is preferably 30 at % or less, more preferably 20 at % or less, relative to the whole rare earth magnet 100 of the present disclosure.

### <Overall Composition>

The rare earth magnet 100 of the present disclosure may be sufficient if it has the hereinbefore-described main phase 10, sub-phase 20 and intermediate phase 30, and the overall composition thereof may be, for example, as follows.

The overall composition of the rare earth magnet 100 of the present disclosure is, for example, represented by SmₓR¹_{y}Fe_{(100-x-y-z-w-p-q)}Co_{z}M¹_{w}NₚO_{q}.(Zn_{(100-s-t-u-v-w)}SiₛSmₜCuᵤM²ᵥO_{w})ᵣ. SmₓR¹_{y}Fe_{(100-x-y-z-w-p-q)}Co_{z}M¹_{w}NₚO_{q} is derived from the magnetic powder, and (Zn_{(1-s-t-u-v-w)}SiₛSmₜCuᵤM²ᵥO_{w})ᵣ is derived from the Zn alloy powder. r is the atomic percentage of the Zn alloy powder relative to the whole magnetic powder. For example, when r is 10 at %, this indicates that 10 at % of Zn alloy powder is blended in the magnetic powder (100 at %) and the rare earth magnet of the present disclosure is obtained.

As described later, the Zn alloy powder contains at least either Si or Sm. In the case where the Zn alloy powder does not contain Sm, the overall composition of the rare earth magnet 100 of the present disclosure is, for example, represented by SmₓR¹_{y}Fe_{(100-x-y-z-w-p-q)}Co_{z}M¹_{w}NₚO_{q}.(Zn_{(100-s-u-v-w)}SiₛCuᵤM²ᵥO_{w})ᵣ. In the case where the Zn alloy powder does not contain Si, the overall composition of the rare earth magnet 100 of the present disclosure is, for example, represented by SmₓR¹_{y}Fe_{(100-x-y-z-w-p-q)}Co_{z}M¹_{w}NₚO_{q}.(Zn_{(100-t-u-v-w)}SmₜCuᵤM²ᵥO_{w})ᵣ.

R¹ is one or more selected from Y, Zr, and rare earth elements other than Sm. M¹ is a sum of one or more selected from Ga, Ti, Cr, Zn, Mn, V, Mo, W, Si, Re, Cu, Al, Ca, B, Ni, and C, and an unavoidable impurity element. M² represents an alloy element other than Zn, Si, Sm and O, and an unavoidable impurity element. x, y, z, w, p, q, r, s, t, u, v, and w are at %.

In the present description, the rare earth element includes Sc, La, Ce, Pr, Nd, Pm, Sm, Eu, Gd, Tb, Dy, Ho, Er, Tm, Yb, and Lu.

Sm is a principal element of the rare earth magnet 100 of the present disclosure, and the content thereof is appropriately determined such that the rare earth magnet 100 of the present disclosure can have the main phase 10 described above. The content x of Sm may be, for example, 4.5 at % or more, 5.0 at % or more, or 5.5 at % or more, and may be 10.0 at % or less, 9.0 at % or less, or 8.0 at % or less.

The rare earth element contained in the rare earth magnet 100 of the present disclosure is mainly Sm, but as long as the effects of the rare earth magnet of the present disclosure and the production method thereof are not inhibited, the main phase 10 may contain R¹. The content y of R¹ may be, for example, 0 at % or more, 0.5 at % or more, or 1.0 at % or more, and may be 5.0 at % or less, 4.0 at % or less, or 3.0 at % or less.

Fe is a principal element of the rare earth magnet 100 of the present disclosure and forms the main phase 10 in cooperation with Sm and N. The content thereof is the remainder after removing Sm, R¹, Co, M¹, N, and O in the formula SmₓR¹_{y}Fe_{(100-x-y-z-w-p-q)}Co_{z}M¹_{w}NₚO_{q}.

A part of Fe may be substituted by Co. When the rare earth magnet 100 of the present disclosure contains Co, the Curie temperature of the rare earth magnet 100 of the present disclosure is increased. The content z of Co may be, for example, 0 at % or more, 5 at % or more, or 10 at % or more, and may be 31 at % or less, 20 at % or less, or 15 at % or less.

M¹ represents a sum of elements added for enhancing specific properties, for example, heat resistance and corrosion resistance, within the range not compromising the magnetic properties of the rare earth magnet 100 of the present disclosure, and unavoidable impurity elements. The content w of M¹ may be, for example, 0.001 at % or more, 0.005 at % or more, 0.010 at % or more, 0.050 at % or more, 0.100 at % or more, 0.500 at % or more, or 1.000 at % or more, and may be 3.000 at % or less, 2.500 at % or less, or 2.000 at % or less.

N is a principal element of the rare earth magnet 100 of the present disclosure, and the content thereof is appropriately determined such that the rare earth magnet 100 of the present disclosure can have the main phase 10 described above. The content p of N may be, for example, 11.6 at % or more, 12.5 at % or more, or 13.0 at % or more, and may be 15.6 at % or less, 14.5 at % or less, or 14.0 at % or less.

Zn binds particles of the magnetic powder (SmFeN powder) and forms an intermediate phase 30 to enhance the coercive force of the rare earth magnet 100 of the present disclosure. The content of Zn derives from the blending amount of the Zn alloy powder at the time of production of the rare earth magnet 100 of the present disclosure. The content of Zn is preferably 0.89 at % (1 mass %) or more, more preferably 2.60 at % (3 mass %) or more, still more preferably 4.30 at % (5 mass %) or more, relative to the whole rare earth magnet 100 of the present disclosure. On the other hand, from the viewpoint of not reducing the magnetization, the content of Zn is preferably 15.20 at % (20 mass %) or less, more preferably 11.90 at % (15 mass %) or less, still more preferably 8.20 at % (10 mass %) or less, relative to the whole rare earth magnet 100 of the present disclosure. The content of Zn is represented by {(100-s-t-u-v-w)×r/100} at % relative to the whole rare earth magnet 100 of the present disclosure.

Si, Sm and Cu in the Zn alloy powder form an alloy with Zn. As described above, Si and Sm in the Zn alloy powder prevent the diffusion of Fe from the oxide phase 10a to the Zn alloy phase 20a (see, FIG. 2). Cu in the Zn alloy powder promotes alloying of Si and/or Sm with Zn. Details are described later.

M² is an unavoidable element other than Zn, Si, Sm, Cu and O, which is unavoidably contained in the Zn alloy powder. M² may be contained in a small amount within the range substantially not affecting the magnetic properties, etc. of the rare earth magnet of the present disclosure.

The contents of the hereinbefore-described Si, Sm, Cu and M² contained in the Zn alloy powder are represented by s, t, u and v (at %), respectively, in the overall composition of the rare earth magnet of the present disclosure. The values of s, t, u and v correspond to the composition of the Zn alloy powder, and therefore can be calculated from the composition range (mass %) of the Zn alloy powder described later.

O (oxygen) is derived from the magnetic powder and the Zn alloy powder and remains (is contained) in the rare earth magnet 100 of the present disclosure. Oxygen is enriched in the intermediate phase 30, so that even when the oxygen content in the whole rare earth magnet 100 of the present disclosure is comparatively high, excellent coercive force can be ensured. The oxygen content relative to the whole rare earth magnet 100 of the present disclosure may be, for example, 5.5 at % or more, 6.2 at % or more, or 7.1 at % or more, and may be 10.3 at % or less, 8.7 at % or less, or 7.9 at % or less. Incidentally, the oxygen content relative to the whole rare earth magnet 100 of the present disclosure is (q+w×r/100) at %. When the oxygen content relative to the whole rare earth magnet 100 of the present disclosure is converted to mass %, the oxygen content may be 1.55 mass % or more, 1.75 mass % or more, or 2.00 mass % or more, and may be 3.00 mass % or less, 2.50 mass % or less, or 2.25 mass % or less.

### <<Production Method>>

The production method of a rare earth magnet of the present disclosure is described below. The rare earth magnet of the present disclosure may be produced by a production method other than the below-described production method as long as the constituent features described hereinbefore are satisfied. The production method of a rare earth magnet of the present disclosure (hereinafter, sometimes referred to as “production method of the present disclosure”) includes a mixed powder preparation step and a heat treatment step. Each step is described below.

### <Mixed Powder Preparation Step>

A magnetic powder and a Zn alloy powder are mixed to obtain a mixed powder. In the following, each of the magnetic powder and the Zn alloy powder is described.

The magnetic powder is not particularly limited as long as it contains the main phase 10 of the rare earth magnet 100 of the present disclosure. As for the main phase 10, the same contents as those described in the rare earth magnet 100 of the present invention can apply.

In the later-descried heat treatment step, when the oxygen content in the Zn alloy powder is small, oxygen in the magnetic powder combines with Zn diffused into the oxide phase 10a during heat treatment and is enriched in the intermediate phase 30, and therefore a magnetic powder having a comparatively large oxygen content can be used. Accordingly, the upper limit of the oxygen content in the magnetic powder may be comparatively high relative to the whole magnetic powder. The oxygen content in the magnetic powder may be, for example, 3.0 mass % or less, 2.5 mass % or less, or 2.0 mass % or less, relative to the whole magnetic raw material powder. On the other hand, although the oxygen content in the magnetic powder is preferably smaller, if the amount of oxygen in the magnetic powder is extremely reduced, this leads to an increase in the production cost. For this reason, the oxygen content in the magnetic powder may be 0.1 mass % or more, 0.2 mass % or more, or 0.3 mass % or more, relative to the whole magnetic powder.

The particle diameter of the magnetic powder is not particularly limited. The particle diameter of the magnetic powder may be, for example, 1 μm or more, 5 μm or more, or 10 μm or more, and may be 50 μm or less, 30 μm or less, or 20 μm or less.

The Zn alloy powder contains, as the alloy element, at least either Si or Sm. The contents of Si and Sm are described below.

If the Si content in the Zn alloy powder is increased, the melting point of the Zn alloy rises, and it becomes difficult for Zn to diffuse into the oxide phase 10a of the main phase 10 in the heat treatment step described later. In addition, if the Si content in the Zn alloy powder is increased, the residual amount of Si in the rare earth magnet 100 of the present disclosure is increased to adversely affect the magnetic properties. From these viewpoints, the Si content in the Zn alloy powder is preferably 1.1 mass % or less, more preferably 1.0 mass % or less. As for the Si content in the Zn alloy powder, 1.1 mass % corresponds to 2.5 at %. On the other hand, in order to prevent Fe in the oxide phase 10a of the main phase 10 from diffusing into the Zn—Fe alloy phase 20b, the Si content in the Zn alloy powder is preferably 0.7 mass % or more, more preferably 0.8 mass % or more. Incidentally, as for the Si content in the Zn alloy powder, 0.7 mass % corresponds to 1.5 at %.

If the Sm content in the Zn alloy powder is increased, the melting point of the Zn alloy rises, and it becomes difficult for Zn to diffuse into the oxide phase 10a of the main phase 10 in the heat treatment step described later. From this viewpoint, the Sm content in the Zn alloy powder is preferably 4.4 mass % or less, more preferably 4.2 mass % or less, still more preferably 4.0 mass % or less. As for the Sm content in the Zn alloy powder, 4.4 mass % corresponds to 2.0 at %. On the other hand, in order to prevent Fe in the oxide phase 10a of the main phase 10 from diffusing into the Zn—Fe alloy phase 20b, the Sm content in the Zn alloy powder is preferably 3.2 mass % or more, more preferably 3.4 mass % or more, still more preferably 3.6 mass % or more. As for the Sm content in the Zn alloy powder, 3.2 mass % corresponds to 1.4 at %.

For alloying at least either Si or Sm with Zn, it is preferable to first obtain an Si—Cu eutectic alloy and/or an Sm—Cu eutectic alloy and add Zn thereto. From this viewpoint, the Cu content in the Zn alloy powder is preferably 0.6 mass % or more, more preferably 0.8 mass % or more, still more preferably 1.0 mass % or more. On the other hand, if the Cu content in the Zn alloy powder is increased, the melting point of the Zn alloy rapidly rises, and it becomes difficult for Zn to diffuse into the oxide phase 10a of the main phase 10 in the heat treatment step described later. From this viewpoint, the Cu content in the Zn alloy powder is preferably 4.9 mass % or less, more preferably 4.0 mass % or less, still more preferably 3.0 mass % or less. Incidentally, as for the Cu content in the Zn alloy powder, 0.6 mass corresponds to 0.6 at %, and 4.9 mass % corresponds to 5.0 at %.

By adjusting the contents of Si, Sm and Cu in the Zn alloy powder as described above, the melting point of the Zn alloy powder can be made substantially equal to the melting point of the Zn powder. In the present description, the Zn powder means metallic Zn powder. The metallic Zn means high-purity Zn not alloyed with an element other than Zn. The purity of metallic Zn may be, for example, 90 mass % or more, 95 mass % or more, 97 mass % or more, or 99 mass % or more.

The embodiment of alloying of Si, Sm and Cu as well as a combination thereof with Zn is not particularly limited and includes, for example, a solid solution, a eutectic, and an intermetallic compound. From the viewpoint of preventing Fe in the oxide phase 10a from diffusing into the Zn alloy phase 20a, Si and/or Sm preferably form a solid solution in the alloy base microstructure. Therefore, it is preferable to add metallic Zn to a Si—Cu eutectic alloy and/or a Sm—Cu eutectic alloy and melt and solidify the mixture, thereby forming a solid solution of Si and/or Sm in the Zn alloy.

The method for alloying Si, Sm and Cu as well as a combination thereof with Zn is not particularly limited as long as the desired alloy composition is obtained. The method for alloying includes, for example, a sintering method of mixing raw material metal powders and heating the mixture at a melting point or less, a chemical method using an aqueous solution containing metal ions, and a mechanical alloying, in addition to a general method of melting and solidifying raw material metals. The melting of raw material metals include are melting, induction heating/melting, etc. In the case of producing an eutectic alloy of Si and Cu, the melting point of Si is high, and therefore are melting is preferably used. In the case where the Zn alloy is obtained in a bulk form, the bulk is cut and pulverized to obtain a Zn alloy powder.

The Zn alloy powder may contain M² as an unavoidable impurity element. The M² content in the Zn alloy powder is preferably smaller and may be 2.0 mass % or less, 1.5 mass % or less, 1.0 mass % or less, 0.5 mass % or less, 0.3 mass % or less, or 0.1 mass % or less, and may be 0 mass %. Incidentally, the unavoidable impurity element indicates an impurity element that is unavoidably contained or causes a significant rise in the production cost for avoiding its inclusion, such as impurity element contained in a raw material of the rare earth magnet or impurity element mixed in the production process.

The Zn alloy powder may contain oxygen (O), in addition to Zn, Si, Sm, Cu and M². When the oxygen content is 1.0 mass % or less relative to the Zn alloy powder, oxygen is easily enriched in the intermediate phase 30 to enhance the coercive force. In view of oxygen enrichment, the oxygen content in the Zn alloy powder is preferably smaller relative to the whole Zn alloy powder. The oxygen content in the Zn alloy powder may be 0.8 mass % or less, 0.6 mass % or less, 0.4 mass % or less, or 0.2 mass % of less, relative to the Zn alloy powder. On the other hand, if the oxygen content in the Zn alloy powder is excessively reduced relative to the Zn alloy powder, this leads to an increase in the production cost. For this reason, the oxygen content in the Zn alloy powder may be 0.01 mass % or more, 0.05 mass % or more, or 0.09 mass % or more, relative to the Zn alloy powder.

The particle diameter of the Zn alloy powder may be appropriately determined in relation to the particle diameter of the magnetic powder so that an intermediate phase 30 can be formed. The particle diameter of the Zn alloy powder may be, for example, 10 nm or more, 100 nm or more, 1 μm or more, 3 μm or more, or 10 μm or more, and may be 1 mm or less, 700 μm, 500 μm or less, 300 μm or less, 100 μm or less, 50 μm or less, or 20 μm or less. In the case where the particle diameter of the magnetic powder is from 1 to 10 μm, in order to unfailingly coat the magnetic powder particle with Zn alloy, the particle diameter of the Zn alloy powder is preferably 200 μm or less, 100 μm or less, 50 μm or less, or 20 μm or less.

By virtue of the Zn alloy powder, particles of the magnetic powder are bound. However, the Zn alloy powder does not contribute to development of magnetism, and therefore if an excessive amount of Zn alloy powder is blended, the magnetization decreases. In view of binding of magnetic powder particles, assuming the mass of the magnetic powder is 1, the mass of the Zn alloy powder may be 0.1 or more, 0.2 or more, 0.4 or more, 0.8 or more, or 1.0 or more. From the viewpoint of suppressing the reduction in magnetization, assuming the mass of the magnetic powder is 1, the mass of the Zn alloy powder may be 3.0 or less, 2.8 or less, 2.6 or less, 2.4 or less, 2.2 or less, 2.0 or less, 1.8 or less, 1.6 or less, 1.4 or less, or 1.2 or less.

In the case of intending to suppress particularly the decrease of magnetization, it is preferable to decrease the content of the Zn component relative to the mixed powder of magnetic powder and Zn alloy powder. In view of binding of magnetic powder particles, the composition of the Zn alloy power and the blending amount of the Zn alloy powder are preferably determined such that the content of the Zn component relative to the mixed powder becomes 1 mass % or more, 3 mass % or more, 6 mass % or more, or 9 mass % or more. From the viewpoint of suppressing the decrease of magnetization, the composition of the Zn alloy power and the blending amount of the Zn alloy powder are preferably determined such that the content of the Zn component relative to the mixed powder becomes 20 mass % or less, 18 mass % or less, or 16 mass % or less.

The method for mixing the magnetic powder and the Zn alloy powder is not particularly limited. The “mixing” encompasses an embodiment where the Zn alloy powder is deformed during mixing of both powders to coat the magnetic powder particle surface with Zn alloy. More specifically, the “mixing” encompasses an embodiment where the magnetic powder surface is coated with Zn while the Zn alloy powder is mixed with the magnetic powder. The mixing method includes a method of mixing the powders by using a mortar, a Muller wheel mixer, an agitator mixer, a mechanofusion, a V-type mixer, a ball mill, and a ball mill, etc. From the viewpoint of facilitating the coating of the outer periphery of the magnetic powder particle with Zn alloy, it is preferable to use a mortar and a ball mill. Incidentally, the V-type mixer is an apparatus having a container formed by connecting two cylindrical containers in V shape, in which the container is rotated to cause the powders in the container to repeatedly experience aggregation and separation due to gravity and centrifugal force and thereby be mixed.

In addition, the mixing encompasses deposition mixing of depositing Zn alloy on the magnetic powder surface. The method for deposition is not particularly limited. The method for depositing Zn alloy includes, for example, a method of forming an organic complex, a method of adsorbing nanoparticles, and a vapor phase method. The vapor phase method includes a vapor deposition method, a PVD method, and a CVD method, etc. The vapor deposition method includes an are plasma deposition method, etc.

### <Heat Treatment Step>

A mixed powder of magnetic powder and Zn alloy powder is heat-treated. As described above, the Zn alloy powder is soft, and therefore when the magnetic powder and the Zn alloy powder are mixed, the surface of the magnetic powder particle is coated with Zn alloy (see, FIG. 2). Diffusing of Zn in the Zn alloy powder into the magnetic powder particle means that, as illustrated in FIG. 2, Zn diffuses from the Zn alloy phase 20a to the main phase 10. Then, as illustrated in FIG. 1, an intermediate phase 30 is formed. At this time, Fe diffuses from the main phase 10 to the Zn alloy phase 20a as illustrated in FIG. 2, as a result, a Zn—Fe alloy phase 20b is formed as illustrated in FIG. 1. However, the alloy element 20d blocks excessive diffusion of Fe from the main phase 10 to the Zn alloy phase 20a, and therefore unlike the conventional rare earth magnet 900, an α-Fe phase 20c is not produced inside of the Zn—Fe alloy phase 20b (see, FIG. 8) as described above.

Since the magnetic powder contains the main phase 10, the heat treatment is performed at a temperature less than the decomposition temperature of the main phase 10. From this viewpoint, the heat treatment temperature may be 500° C. or less, 490° C. or less, or 480° C. or less. On the other hand, the heat treatment is performed at a temperature equal to or higher than the temperature allowing Zn in Zn alloy to diffuse into the oxide phase 10a on the surface of the main phase 10. The diffusion of Zn in Zn alloy into the oxide phase 10a on the main phase 10 surface may be either solid phase diffusion or liquid phase diffusion. The liquid phase diffusion means that liquid-phase Zn diffuses into the solid-phase oxide phase 10a.

From the viewpoint of allowing solid-phase Zn to undergo solid phase diffusion into the oxide phase 10a on the main phase 10 surface, the heat treatment temperature may be 350° C. or more, 370° C. or more, 390° C. or more, or 410° C. or more. From the viewpoint of allowing liquid-phase Zn to diffuse into the oxide phase 10a on the main phase 10 surface, the heat treatment temperature may be equal to or higher than the melting point of Zn alloy, i.e., 420° C. or more, 440° C. or more, or 460° C. or more.

In addition, mixing and heat treatment may be performed at the same time by charging the magnetic powder and the Zn alloy powder into a rotary kiln.

The heat treatment time may be appropriately determined according to the amount, etc. of the mixed powder. The heat treatment time excludes the temperature rise time until reaching the heat treatment temperature. The heat treatment time may be, for example, 5 minutes or more, 10 minutes or more, 30 minutes or more, or 50 minutes or more, and may be 600 minutes or less, 240 minutes or less, or 120 minutes or less.

After the elapse of the heat treatment time, the heat treatment is terminated by rapidly cooling the heat-treatment object. Oxidation, etc. of the rare earth magnet 100 of the present disclosure can be prevented by rapid cooling. The rapid cooling rate may be, for example, from 2 to 200° C./sec.

The heat treatment is preferably performed in an inert gas atmosphere or in vacuum so as to prevent oxidation of the mixed powder. The inert gas atmosphere includes a nitrogen gas atmosphere.

Besides the hereinbefore-described mixed powder preparation step and heat treatment step, the following steps may be added.

### <Compression Molding Step>

The mixed powder may be, before heat treatment, compression-molded to obtain a green compact, and the green compact may be heat-treated. When the mixed powder is compression-molded, individual particles of the mixed powder are closer together, so that a good intermediate phase 30 can be formed and the coercive force can be enhanced. The compression molding method may be a conventional method such as pressing using a mold. The pressing pressure may be, for example, 30 MPa or more, 40 MPa or more, 50 MPa or more, 100 MPa or more, or 150 MPa or more, and may be 1,500 MPa or less, 1,000 MPa or less, or 500 MPa or less.

The compression molding of the mixed powder may be performed in a magnetic field. By this molding, orientation can be imparted to the green compact, and the magnetization can be enhanced. The method for compression molding in a magnetic field may be a method generally performed at the time of production of a magnet. The magnetic field applied may be, for example, 0.3 T or more, 0.5 T or more, or 1.0 T or more, and may be 5.0 T or less, 4.0 T or less, or 3.0 T or less.

### <Sintering>

One embodiment of heat treatment includes performing the heat treatment while applying pressure, for example, sintering. In the production method of the present disclosure, the mixed powder or green compact may be heat-treated while pressure is applied, i.e., may be sintered. In the sintering, pressure is applied to the mixed powder or green compact, and therefore the effect due to heat treatment is unfailingly obtained in a short time. The sintering encompasses liquid-phase sintering in which a part of the sintering object becomes a liquid phase.

Sintering conditions are described below. The sintering temperature may be determined with reference to the above-described heat treatment temperature. The sintering pressure may be a pressure employed in the sintering step of a rare earth magnet. The sintering pressure may be, typically, 50 MPa or more, 100 MPa or more, 200 MPa or more, or 400 MPa or more, and may be 2 GPa or less, 1.5 GPa or less, 1.0 GPa or less, or 700 MPa or less. In the sintering, pressure is applied to the mixed powder or green compact, and therefore the sintering time may be short compared with the above-described heat treatment time. The sintering time may be, typically, 1 minute or more, 3 minutes or more, or 5 minutes or more, and may be 120 minutes or less, 60 minutes or less, or 40 minutes or less. In the sintering, it may also be possible to apply no pressure until reaching the desired temperature and start applying pressure after reaching the desired temperature. In this case, the sintering time is preferably the time from the start of applying pressure.

After the elapse of the sintering time, the sintering is terminated by taking out the sintering object from the mold. The sintering is preferably performed in an inert gas atmosphere or in vacuum so as to prevent oxidation of the magnetic powder and the Zn alloy powder. The inert gas atmosphere includes a nitrogen gas atmosphere.

The sintering method may be a conventional method and includes, for example, Spark Plasma Sintering (SPS) and hot press. In the case of intending to apply pressure after the sintering object has reached the desired temperature, hot press is preferred.

At the time of sintering, typically, a mold made of cemented carbide or iron and steel material is used, but the present disclosure is not limited thereto. Here, the cemented carbide is an alloy obtained by sintering tungsten carbide and cobalt as a binder. The iron and steel material used for the mold includes, for example, carbon steel, alloy steel, tool steel and high-speed steel. The carbon steel includes, for example, SS540, S45C, and S15CK of the Japanese Industrial Standards. The alloy steel includes, for example, SCr445, SCM445, and SNCM447 of the Japanese Industrial Standards. The tool steel includes, for example, SKD5, SKD61, and SKT4 of the Japanese Industrial Standards. The high-speed steel includes, for example, SKH40, SKH55, and SKH59 of the Japanese Industrial Standards.

### EXAMPLES

The rare earth magnet of the present disclosure and the production method thereof are described more specifically below by referring to Examples and Comparative Examples.

Incidentally, the rare earth magnet of the present disclosure and the production method thereof are not limited to the conditions employed in the following Examples.

### Preparation of Sample

Samples of the rare earth magnet were prepared in the following manner.

### Examples 1 and 2

A magnetic powder mainly containing Sm₂Fe₁₇N₃ was prepared. The oxygen content in the magnetic powder was 1.05 mass %, and the particle diameter of the magnetic powder was 5 μm.

A Zn alloy powder was prepared. As the Zn alloy powder, a Zn—Si—Cu alloy powder and a Zn—Sm—Cu alloy powder were prepared.

As for the Zn—Si—Cu alloy, Si and Cu were blended in a ratio of 4:21 (mass ratio) (a ratio of 3:7 (ratio of number of atoms)), and the mixture was arc-melted to obtain an Si—Cu alloy. Then, the Si—Cu alloy and Zn were blended in a ratio of 4.1:95.9 (mass ratio) (a ratio of 5:95 (ratio of number of atoms)), and the mixture was high-frequency-melted to obtain a Zn—Si—Cu alloy. The composition of the Zn—Si—Cu alloy was, in mass %, Zn 95.9%-Si 0.7%-Cu 3.4%. The Zn—Si—Cu alloy was cut and pulverized to obtain a Zn—Si—Cu alloy powder. The Zn—Si—Cu alloy powder had a particle diameter of 1 mm or less and an oxygen content of 0.35 mass %.

As for the Zn—Sm—Cu alloy, Sm and Cu were blended in a ratio of 3.16:0.6 (mass ratio) (a ratio of 7:3 (ratio of number of atoms)), and the mixture was high-frequency-melted to obtain an Sm—Cu alloy. Then, the Sm—Cu alloy and Zn were blended in a ratio of 3.8:96.2 (mass ratio) (a ratio of 2:98 (ratio of number of atoms)), and the mixture was high-frequency-melted to obtain a Zn—Sm—Cu alloy. The composition of the Zn—Sm—Cu alloy was, in mass %, Zn 96.2%-Sm 3.2%-Cu 0.6%. The Zn—Sm—Cu alloy was cut and pulverized to obtain a Zn—Sm—Cu alloy powder. The Zn—Sm—Cu alloy powder had a particle diameter of 1 mm or less and an oxygen content of 0.30 mass %.

The magnetic powder and the Zn alloy powder were mixed to obtain a mixed powder. The mixed powder was then compression-molded in a non-magnetic field to obtain a green compact. Furthermore, the green compact was sintered to obtain a sintered body. This sintered body was used as samples of Examples 1 and 2. As for the sintering conditions, the green compact was heated to a predetermined temperature without applying pressure and held, and at the predetermined temperature, the green compact was sintered while pressure is applied.

### Comparative Example 1

Sample of Comparative Example 1 was produced in the same manner as in Examples 1 and 2 except that a Zn powder was used in place of the Zn alloy powder.

### Evaluation

Each sample was evaluated for the magnetic properties by using a pulse excited magnetometer (TPM). The measurement was performed at room temperature.

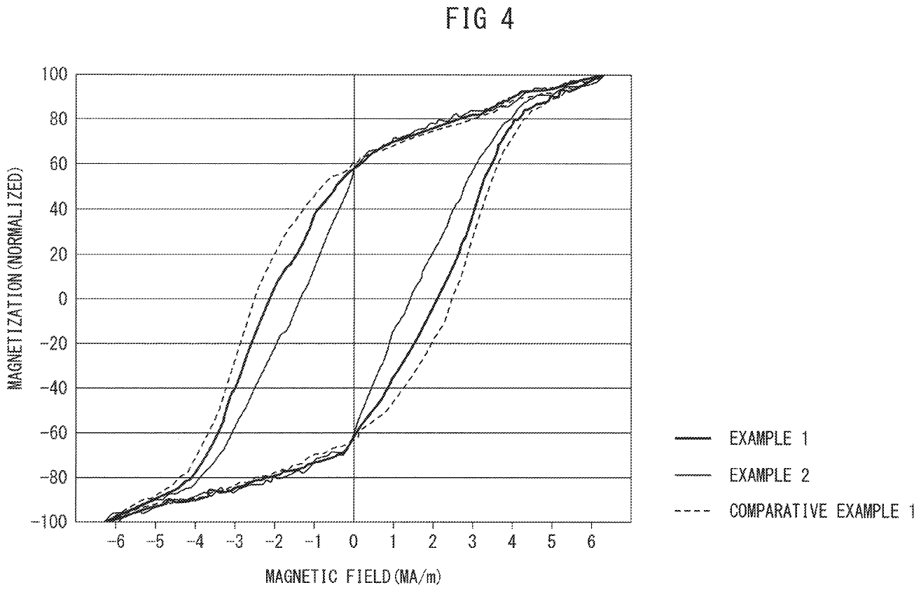

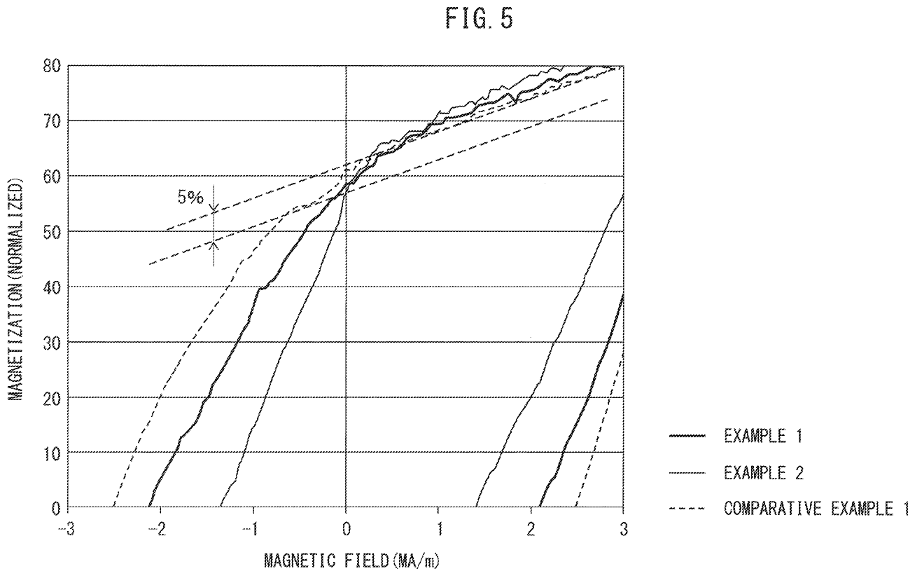

The evaluation results are shown in Table 2. In Table 2, the mass ratio between the magnetic powder and the Zn alloy powder or Zn powder, the compression molding conditions, and the sintering conditions are shown together. FIG. 4 is an M-H curve with respect to samples of Examples 1 and 2 and Comparative Example 1. FIG. 5 is a diagram enlarging the region where the magnetic field is 0 MA/m in FIG. 4. In FIG. 4, with respect to Comparative Example 1, the method for calculating the “percentage of knick” shown in Table 2 is illustrated together.

TABLE 2

| | | | | | Sintering | | | | | | | |
|---|---|---|---|---|---|---|---|---|---|---|---|---|
| | Zn Alloy or Zn Powder | | Compression Molding | | Holding Time | | | | | | | |
| | | Blending | | Magnetic | Before | | | | | Magnetic Properties | | |
| | | Ratio | | Field | Applying | | | | | Percentage | | |
| | | (mass | Pressure | Applied | Pressure | Temperature | Pressure | Time | Atmo- | of Knick | He | Br*²⁾ |
| | Type | ratio)* 1 | (MPa) | (T) | (min.) | (° C.) | (MPa) | (min) | sphere | (%) | (kOe) | (%) |
| Example 1 | ZnSiCu | 1:2 | 50 | none | 3 | 475 | 50 | 5 | Ar | 0 | 17.2 | 58 |
| Example 2 | ZnSmCu | 1:2 | 50 | none | 3 | 475 | 50 | 5 | Ar | 0 | 26.4 | 57 |
| Comparative | Zn | 1:2 | 50 | none | 3 | 475 | 50 | 5 | Ar | 5 | 31.4 | 61 |
| Example 1 | | | | | | | | | | | | |

* 1(mass of magnetic powder):(mass of Zn alloy powder) or (mass of magnetic powder):(mass of Zn powder)
*²⁾Br is normalized by taking magnetization at 6.25 MA/m as 100.

It could be confirmed from Table 2 that samples of Examples 1 and 2 using a Zn alloy powder are prevented from generation of a knick.

These results could verify the effects of the rare earth magnet of the present disclosure and the production method thereof.

### DESCRIPTION OF NUMERICAL REFERENCES

10 Main phase
10a Oxide phase
20a Zn alloy phase
20b Zn—Fe alloy phase
20c α-Fe phase
20d Alloy element
20 Sub-phase
25a Zn phase
Intermediate phase
50 Interface
100 Rare earth magnet of the present disclosure
900 Conventional rare earth magnet

1. A rare earth magnet comprising:
a main phase containing Sm, Fe, and N, at least a part of the main phase having a Th₂Zn₁₇-type or Th₂Ni₁₇-type crystal structure,
a sub-phase containing at least either Si or Sm, and Zn and Fe and being present around the main phase, and
an intermediate phase containing Sm, Fe and N as well as Zn and being present between the main phase and the sub-phase,
wherein the average Fe content in the sub-phase is 33 at % or less relative to the whole sub-phase, and the average total content of Si and Sm in the sub-phase is from 1.4 to 4.5 at % relative to the whole subs-phase.

2. The rare earth magnet according to claim 1, wherein the average Fe content in the sub-phase is from 1 to 33 at % relative to the whole sub-phase.

3. The rare earth magnet according to claim 1, wherein the sub-phase further contains Cu.

4. The rare earth magnet according to claim 1, wherein the sub-phase contains one or more Zn—Fe alloy phases selected from the group consisting of a Γ phase, a Γ₁ phase, a δ₁ₖ phase, a δ₁ₚ phase, and a ζ phase and at least a part of Zn or Fe of the Zn—Fe alloy phase is substituted by at least either Si or Sm.

5. The rare earth magnet according to claim 4, wherein at least a part of Zn or Fe of the Zn—Fe alloy phase is further substituted by Cu.

6. The rare earth magnet according to claim 1, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

7. The rare earth magnet according to claim 1, wherein the main phase contains a phase represented by Sm₂Fe₁₇Nₕ (wherein h is from 1.5 to 4.5).

8. The rare earth magnet according to claim 1, wherein the main phase contains a phase represented by Sm₂Fe₁₇N₃.

9. A method for producing a rare earth magnet, comprising:
mixing a magnetic powder and a Zn alloy powder to obtain a mixed powder, the magnetic powder comprising a main phase containing Sm, Fe, and N, at least a part of the main phase having a Th₂Zn₁₇-type or Th₂Ni₁₇-type crystal structure, the Zn alloy powder containing, as an alloy element, at least either Si or Sm,
heat-treating the mixed powder at a temperature equal to or higher than the temperature allowing Zn to diffuse into the oxide phase on the surface of the main phase and less than the decomposition temperature of the main phase.

10. The method according to claim 9, wherein the Si content in the Zn alloy powder is from 0.7 to 1.1 mass % relative to the Zn alloy powder.

11. The method according to claim 9, wherein the Sm content in the Zn alloy powder is from 3.2 to 4.4 mass % relative to the Zn alloy powder.

12. The method according to claim 9, wherein the Zn alloy powder further contains Cu.

13. The method according to claim 9, wherein the Cu content in the Zn alloy powder is from 0.6 to 4.9 mass % relative to the Zn alloy powder.

14. The method according to claim 9, wherein the mixed powder is compression-molded to obtain a green compact and the green compact is heat-treated.

15. The method according to claim 14, wherein the compression molding is performed in a magnetic field.

16. The method according to claim 9, wherein the mixed powder or green compact is heat-treated while pressure is applied.

17. The method according to claim 9, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

18. The method according to claim 9, wherein the main phase contains a phase represented by Sm₂Fe₁₇Nₕ (wherein h is from 1.5 to 4.5).

19. The method according to claim 9, wherein the main phase contains a phase represented by Sm₂Fe₁₇N₃.

20. The method according to claim 9, wherein the heat treatment is performed at 350 to 500° C.

21. The method according to claim 9, wherein the heat treatment is performed at 420 to 500° C.
